(19) United States
(12) Patent Application Publication
(10) Pub. No.: US 2006/0042923 A1
(43) Pub. Date: Mar. 2, 2006

(54) Hyper thin tactile keyboard assembly

(76) Inventors: Emmanuel De Richecour, Fromentieres/LeRoche (FR); Stephane Munsch, Palaiseau (FR)

Correspondence Address: MOLEX INCORPORATED, 2222 WELLINGTON COURT, LISLE, IL, 60532, US

(21) Appl. No.: 10/932,168

(22) Filed: Sep. 1, 2004

(51) Int. Cl. H01H 1/10

(52) U.S. Cl. 200/512

(57) ABSTRACT

The invention relates to a tactile keyboard assembly providing at least one key and constructed on a plurality of foil layers stacked one upon the other, with one layer thereof composed of a dome layer having for each key an elastically deformable dome positioned underneath the respective key.

For providing a new and improved structure of a such tactile multi-layered foil keyboard assembly enabling an effective reduction of the thickness, the invention proposes a tactile keyboard assembly for an electronic device, the assembly is constructed on a plurality of foil layers stacked one upon the other and providing the basic structure for at least one tactile key, with one layer of the plurality of layers composed of a dome layer (120, 125) having an elastically deformable dome (125) for each key, and with each dome (125) positioned underneath a respective user area for the key actuation such that the surface of the dome (125) is forming a convex surface with regard to the user area for the key actuation.

### FIELD OF THE INVENTION

The invention relates to a tactile keyboard assembly providing at least one key and constructed on a plurality of thin layers stacked one upon the other, with one layer thereof composed of a dome support layer having for each key an elastically deformable dome positioned underneath the respective key.

### BACKGROUND OF THE INVENTION

Often, a standard keyboard assembly is based on a multi-layered structure with an elastically deformable dome-shaped member placed there between and underneath a respective key button. An actuator part of the key button is placed on the outer surface of the dome at the vertex thereof from which the dome opens up to an annular rim placed on a lower layer providing electrical contact terminals. By applying an external pressure onto the key button and hence onto the top surface of the dome, the dome is deformed such that the inner surface thereof is contacting the electrical contact terminals provided under the dome.

A section through a key of such a standard keyboard assembly is schematically depicted in appended FIG. 5. As can be seen therefrom, a key button 10, for example a moulded key button is provided with an actuator pin 15 integrated formed with the key button or attached thereto. The actuator pin 15 is directly placed onto the top of the outer surface of a metal dome 25 connected to a dome support foil 20 typically made of a plastic film. The metal dome 25 is positioned above a flex foil 30 with its open annular rim such that the surface of the dome 25 is defining with regard to the key button 10 or actuator pin 15 a kind of concave surface and with regard to the flex foil 30 a kind of convex surface. The flex foil 30 usually forming the basic layer comprises an electrical circuit including conductive terminals 35 typically within the annular mouth of a respective dome 25 being of metal material. By actuating the key button 10, the actuator pin 15 is pressing the dome 25 causing a deformation of the dome 25 such that the inner surface of the metal dome 25 is depressed against the flex foil 30 for enabling the connection between the conductive terminals 35. Usually, the flexural deformation of the dome 25 provides the user with a tactile key operating feedback. The key button 10 may be covered and/or held in position by specific means, for example by a correspondingly thermoformed graphic layer 50 enclosing the key button, as depicted. Moreover, between the dome support foil 20 and the uppermost graphic layer 50 an electro-luminescent lamp foil 40 may be sandwiched layered for emitting light through the graphic layer 50 in the direction of a user of the keyboard.

However, one of the main problems involved with a such or similar construction of providing a tactile multi-layered keyboard assembly concerns the overall thickness involved therewith, in particular in case the tactile keyboard is intended for use in small electronic devices, such as mobile phones or other handheld electronic devices. Hence the industries, for example the mobile phone industries, struggle to reduce the thickness of such keyboards by keeping or even improving the tactility.

### SUMMARY OF THE INVENTION

A main object of the invention is therefore to provide with regard to the above discussed state of the art a new and improved structure of a tactile multi-layered foil keyboard assembly enabling an effective reduction of the thickness.

The inventive solution of this object is surprisingly achieved by a subject matter having the features according to one of the appended independent claims.

Advantageous and/or preferred embodiments or refinements are the subject matter of the respective dependent claims.

Accordingly, the invention proposes to provide a tactile keyboard or keypad assembly for an electronic device in that the assembly is constructed on a plurality of thin layers, in particular of foil-based layers, stacked one upon the other providing the basic structure for at least one tactile key, with one layer of the plurality of layers composed of a dome layer having an elastically deformable dome for each key, wherein the dome is positioned underneath the respective user area for key actuating or operating with its annular rim aligned thereto and with its vertex oriented to the opposite direction thereby forming or defining convex surfaces with regard to the key actuating user area.

Hence, due to the reverse orientation of the dome, with regard to the state of the art, the dome rim itself is defining an key area which is sufficient for ensuring a precise key operation by a user for applying an external force resulting in an definable flexural deformation of the dome without the additional need of a separate key button, as compared to the state of the art. Hence, the overall thickness of a keyboard assembly can be reduced in a considerable manner by simultaneously keeping the tactile operating feedback of such an inventive keyboard assembly as a user is customized to.

It is a further object of the invention to easily provide for a user a good identification functionality of the keys and/or key-operating areas. This is achieved by providing an upper layer covering and protecting the lower foil layers by a graphic foil layer forming the user visible surface of the inventive keyboard assembly by graphically defining, in particular by means of pictograms, the respective key areas which have to be applied with pressure in case of a respective user key selection. Since additional key buttons are not comprised by the inventive assembly and hence, the surface of the inventive assembly in substantial is planar, the graphical foil layer does not have to be thermoformed.

For providing an electrical connectivity functionality in response to a key operation, a flex foil comprising an electrical circuit is placed upon the dome rims of the dome layer, such that respective conductor connection terminals of the electrical circuit are preferably positioned within the areas defined by the annular dome rims underneath the flex foil. Thus, by the compression of a dome in response to an external pressure applied to the associated key area the inside surface of the dome presses onto the terminals and causes an electrical connection for closing the conductor of the electrical circuit which is assigned to the key.

For further improving a safe conduction functionality without the need of applying an undue external pressure, the at least one dome preferably is made of conductive material for closing the conductor, i.e. by directly contacting the respective conductor connection terminals with the inner surface of the dome. The dome itself may be integrally formed with the dome layer. However, at least in case the dome is made of conductive material the dome is attached to a dome support foil made of plastic by any suitable means, such as by an adhesive for example.

It is still a further object to increase the tactile key operating feedback and to further improve the safe conduction functionality. This is preferably achieved by an actuator layer positioned underneath the dome layer comprising an actuator plunger or pin directly underneath the vertex at the backside or the outside of each deformable dome for defining a kind of counteracting stop being supportive of a precise and tactile compression of the dome in response to an external pressure applied to the key area by a user.

The actuator plunger or pin are preferably moulded or printed on an actuator support foil made of a plastic material for providing withstand force and rigidity or being part of a plastic case for an electronic device on which the keyboard is placed.

To further activate the tactility of the key areas it is proposed to add an UV ink layer screenprinted on top of the graphic layer at the precise position of the key areas for supportingly simulating a key button.

Moreover, for providing a good readability or recognisability of the keyboard and in particular of the respective keys or key areas a light emitting layer, such as an electro-luminescent layer may be additionally embedded between the graphic layer and the flex foil layer with the light emitting side oriented to the graphic layer. An electrical power supply for stimulating the light emitting means embedded within such light emitting layer may be easily provided by the circuit of the flex foil directly adjacent the light emitting layer.

Accordingly, a very preferred embodiment of the inventive keyboard or keypad assembly constructed on a plurality of foil-based layers stacked one upon the other includes a lower actuator foil layer, stacked thereon a metal dome foil layer, stacked thereon a flex foil layer, stacked thereon an electro-luminescent foil layer and stacked thereon a graphic foil layer.

An electronic device having such an inventive tactile keyboard assembly thus can be provided with an overall decreased thickness and hence, such an electronic device is preferably a handheld electronic device such as a mobile phone, a MDA (Mobile Digital Assistant), a PDA (Personal Digital Assistant) or a WDA (Wireless Digital Assistant).

The above and other features and advantages will be more apparently by the following description of a preferred embodiment of the invention and with reference to the accompanied drawings.

### BRIEF DESCRIPTION OF THE DRAWINGS

FIG. 1 is showing a schematic view of the several staked layers of a first embodiment of tactile keyboard assembly according to the invention,

FIG. 2 is showing a schematic cross sectional area through a centre of a key, such as along the line A-A of FIG. 1, depicting the layered structure of a tactile key of a second embodiment according to the invention in an initial condition when the key is not actuated,

FIG. 3 is showing the schematic cross sectional area according to FIG. 2, but in a compressed condition when the key is actuated,

FIG. 4 is schematically showing a plastic case on which whole keyboard may be placed with actuators suitable for the inventive keyboard assembly and being part of the case, and

FIG. 5 is schematically showing a standard construction.

### DESCRIPTION OF THE PREFERRED EMBODIMENTS

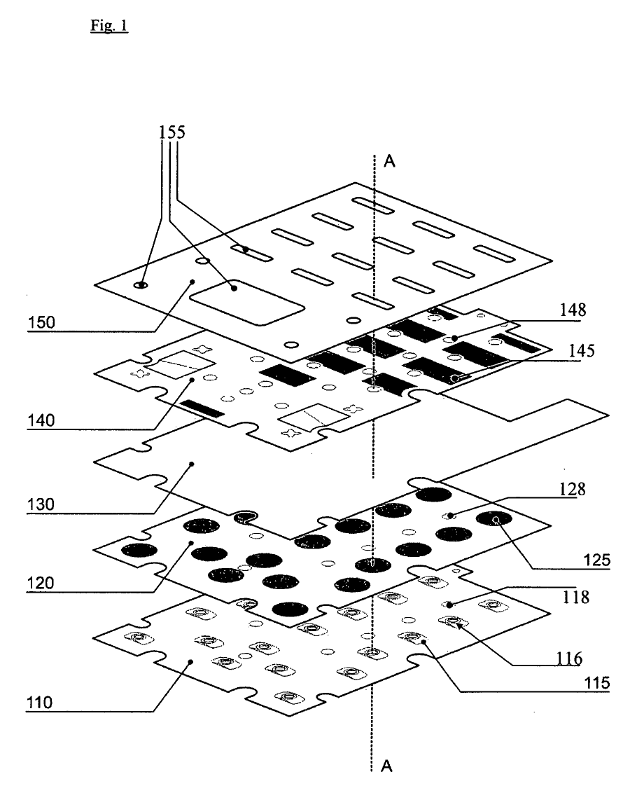

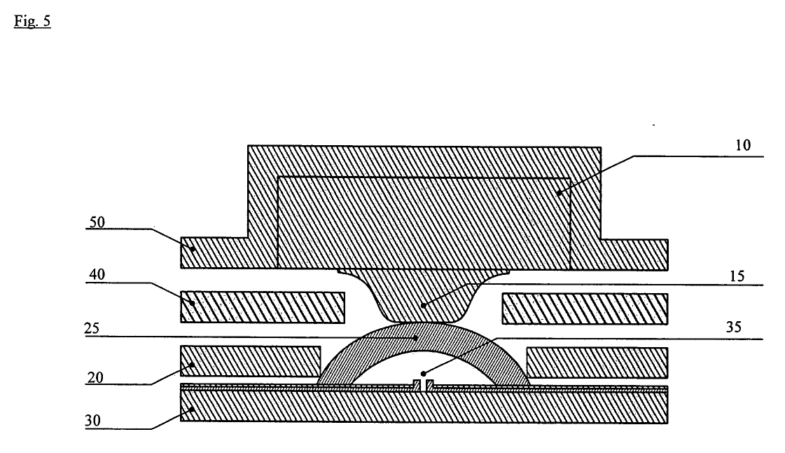

As shown in FIG. 1 depicting a first preferred embodiment of the inventive multi-layered keyboard assembly, this keyboard assembly includes as the basic layer an actuator layer 110. According to FIG. 1, this actuator layer is made of a thin plastic film 110 with actuator pins or plungers 115 injected. On the actuator layer 110 then a dome layer comprising a dome support plastic foil 120 supporting a plurality of metal domes 125, a layer of a flex foil 130 comprising an electrical circuit (not shown in FIG. 1), a layer of an electro-luminescent foil 140 and a layer of a graphic foil 150 are respectively stacked one upon each other. Thus, the dome support foil 120 and the flex foil 130 are in a reversed order as compared with the standard keyboard construction of FIG. 5.

Generically and according to the preferred embodiments, each of the foils is based on a thin film of plastic material. In addition, in particular the foils 110, 120 and 140 may have a pre-given amount of clearance holes 118, 128 or 148 for an easy and adaptable assembly of the foils with the mechanical and electrical components depending on a respective certain intended keyboard design.

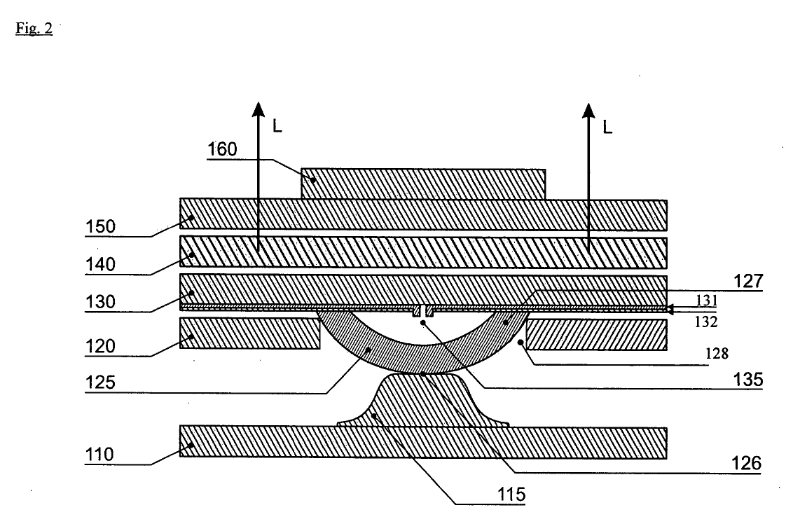

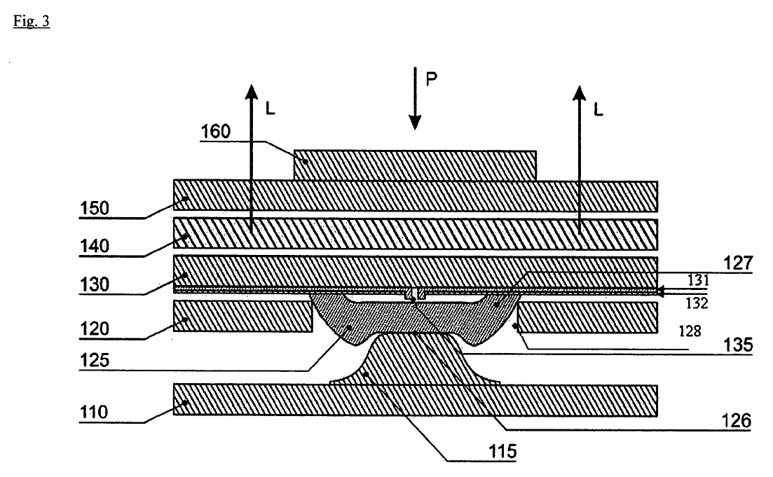

Furthermore, the electro-luminescent foil 140 includes a plurality of light emitting lamp means 145 for emitting light through the graphic layer 150, as indicated in FIGS. 2 and 3 by the arrows L. The light emitting lamp means 145 as depicted in FIG. 1, are arranged for an areal illumination of the keyboard surface. For enabling such functionality, the basic plastic film of the electro-luminescent foil 140 preferably is provided with several printed inks on it, such as ITO (Indium Tin Oxide), dielectric, AG (silver) and C (carbon), for correspondingly providing anodes and cathodes with intermediate luminescent materials. The power supply (not depicted) for the electrical stimulation is provided by the printed electrical circuit of the flex foil 130. For providing the electrical circuit the plastic material of flex foil 130 may be laminated correspondingly with copper, referenced in FIGS. 2 and 3 by reference sign 131, covered by an isolation, referenced in FIGS. 2 and 3 by reference sign 132.

Moreover, the graphic foil 150 is provided with pictograms 155 visually representing respective keys for a user. Each of the plurality of flexural deformable metal domes 125 embedded within the dome support plastic foil 120 and hence electrically isolated to each other is aligned with respective one of the actuator pins or plungers 115 supported by the actuator foil 110 and arranged such, that at least one dome 125 and one pin 115 each positioned precise underneath a pictogram 155 representing a key.

Thus, as can be seen from FIGS. 2 and 3 schematically showing cross sectional areas through a centre of a key, such as along the line A-A of FIG. 1, of a slightly different embodiment of the inventive multi-layered keyboard assembly, not only the dome support foil 120 and the flex foil 130 are in a reversed order as compared with the standard keyboard construction of FIG. 5 but also the dome 125 itself is in a reversed orientation as compared with the dome 25 of the standard keyboard construction of FIG. 5.

The metal dome 125 is positioned such within a clearance hole 128, that the vertex 126 of the dome 125 is oriented to the opposite direction of the user visible keyboard surface and it opens up towards the keyboard surface to an annular dome rim 127 on which the flex foil 130 is arranged. Thus, the annular dome rim 127 itself is defining an key area which is sufficient for ensuring a precise key operation by a user by applying an external force without the additional need of a separate key button.

As a result, the overall thickness of the inventive keyboard assembly can be reduced mostly because there is no molded key or separate key button necessary. With regard to a thickness of about 2.50 mm of a standard construction as depicted in FIG. 5, the thickness of the inventive reversed keyboard construction can be decreased down to about 1.56 mm and moreover. As a consequence the inventive keyboard assembly is very suitable for small electronic devices, such as handheld electronic devices like mobile phones or a PDA for example.

Due to the isolation cover 132 of the flex foil 130, the metal dome 125 and the electrical circuit 131 are electrical isolated. Within the mouth area defined by the dome rim 127 the flex foil 130 is provided with conductive terminals 135 of the printed circuit 131. Applying an external pressure P on top of the key area causes a flexural deformation of the dome 125 such that the inner surface of the metal dome 125 comes into contact with the conductive terminals 135 thereby enabling the electrical connection and providing the user with a tactile key operating feedback.

As an alternative, conductive terminals of the flex foil may be formed and arranged such, that in response to an external pressure the inner dome surface of the deformed dome causes that both conductive terminals are getting in contact to each other. Correspondingly, for such an alternative, the dome 125 does not have to be of metal material and hence, using a non conductive dome an electrical isolation between the dome and the flex foil electrical circuit is not obligatory and the dome may be formed as an integral part of the dome layer, in particular of a correspondingly formed dome support foil.

It can be further seen from FIG. 2 and 3, that a respective actuator plunger or pin 115 of the actuator layer 110 underneath the dome layer may be formed and positioned directly underneath the vertex 126 at the backside or the outside of the deformable dome 125 for being supportive of a precise compression of the dome 125 in response to an external pressure applied to the key area by a user, for improving the safe conduction functionality and for enhancing a tactile key operating feedback for the user.

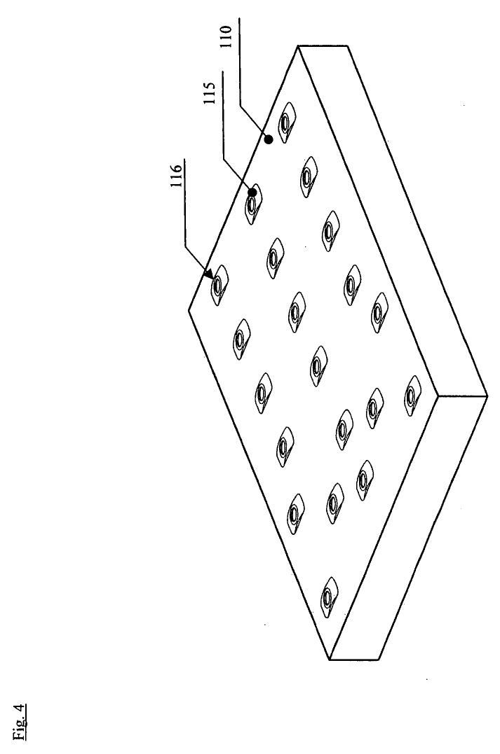

However as an alternative and as depicted in FIGS. 1 and 4, the actuator plunger or pin 115 also may be formed with a kind of ring-shaped rim 116 providing a small mouth area within which the dome vertex is positioned.

The actuator plunger or pin 115 and the actuator support layer 110 may be produced in one or more pieces. For example, the actuator plunger or pin 115 can be moulded, injected or printed on an actuator support foil made of a plastic material providing sufficient withstand force and rigidity as described above. It is noted however, that the actuator support layer also may be provided by a plastic case, as depicted in FIG. 4, or the like on which the whole keyboard is placed with the actuator plunger or pin 1115 being a part of the plastic case, for example.

Moreover, as depicted in FIGS. 2 and 3, on top of the graphic layer 150, at the precise position of the key area, an additional UV ink layer 160 is optionally screen printed for supportingly simulating a key button and to keep a good feeling with the fingers when touching the key area. Such a layer 160 also may be provided with a Braille or embossed printing.

What is claimed is:

1. A tactile keyboard assembly for an electronic device, the assembly is constructed on a plurality of thin layers stacked one upon the other and providing the basic structure for at least one tactile key, with one layer of the plurality of layers composed of a dome layer (120, 125) having an elastically deformable dome (125) for each key, characterized in that
each dome (125) is positioned underneath a respective user area for the key actuation such that the surface of the dome (125) is forming a convex surface with regard to the user area for the key actuation.

2. The tactile keyboard assembly of claim 1, further characterized by an upper graphic layer (150) defining the surface of the keyboard assembly and the user areas for the key actuation.

3. The tactile keyboard assembly of claim 2, wherein the graphic layer is based on thin foil of plastic material.

4. The tactile keyboard assembly of claim 2, further characterized by at least one UV ink layer (160) on the graphic layer (150) for simulating a kind of tactile key button.

5. The tactile keyboard assembly of claim 4, characterized by a light emitting layer (140) directly underneath the graphic layer (150) for emitting light therethrough.

6. The tactile keyboard assembly of claim 5, wherein the light emitting layer (140) is comprises an electro-luminescent foil.

7. The tactile keyboard assembly of claim 1, further characterized by a layer having a flex foil (130) comprising electrical circuit terminals (135), with the deformable dome (125) being positioned underneath the flex foil (130) and adapted for causing an electrical connection of circuit terminals (135) in response to an external pressure applied to the key resulting in a deformation of the dome (125).

8. The tactile keyboard assembly of claim 7, wherein each elastically deformable dome (125) opens up from a dome vertex (126) to an annular dome rim (127) abutting on the flex foil layer.

9. The tactile keyboard assembly of claim 8, wherein the flex foil layer comprises an electrical circuit (131) on the flex foil (130).

10. The tactile keyboard assembly of claim 9, wherein electrical circuit terminals (125) of the electrical circuit (131) of the flex foil (130) are positioned within the area defined by the annular dome rim (1 27).

11. The tactile keyboard assembly of claim 1, wherein the dome (125) is made of conductive material.

12. The tactile keyboard assembly of claim 11, wherein the dome (125) comprises an annular dome rim (127) abutting on an isolation film (131) covering an electrical circuit (131) printed on a flex foil (130).

13. The tactile keyboard assembly of claim 1, wherein the at least one deformable dome (125) is integrally formed with the dome layer or may be mounted to a dome support foil (120) of the dome layer.

14. The tactile keyboard assembly of claim 1, further characterized by an actuator layer (110) underneath the dome layer (120, 125) comprising underneath each deformable dome (125) an actuator plunger or pin (115) for supporting the deformation of the dome (125) in response to an external pressure (P) applied to the key.

15. The tactile keyboard assembly of claim 14, wherein the actuator plunger or pin (115) is injected, molded or printed on an actuator foil (110) made of a plastic material or is being a part of a plastic case on which whole keyboard is placed.

16. A tactile keyboard assembly for an electronic device constructed on a plurality of thin layers stacked one upon the other, the assembly is including a lower actuator layer (110, 115), stacked thereon a layer comprising deformable domes (125) supported by a plastic foil (120), stacked thereon a layer comprising a flex foil (130) providing electrical circuit terminals (135), stacked thereon a layer comprising an electro-luminescent foil (140) and stacked thereon a graphic foil layer (150).

17. The tactile keyboard assembly of claim 16, wherein the vertex (126) of the domes (125) opens up from a dome vertex (126) abutting to the actuator layer (110, 115) to an annular dome rim (127) abutting to the layer comprising the flex foil (130).

18. The tactile keyboard assembly of claim 16, wherein the actuator layer (110, 115) comprises actuator plungers or pins (115) injected, molded or printed on a foil (110) made of a plastic material or being part of a plastic case on which whole keyboard is placed.
